(19) United States
(12) Patent Application Publication
(10) Pub. No.: US 2010/0017326 A1
(43) Pub. Date: Jan. 21, 2010

(54) Credit Handler For Entertainment Device

(75) Inventors: Alistair Hopkins, Gwynedd (GB); Andrew Guy Olliver, East Sussex (GB)

Correspondence Address: William J. McNichol, Jr, Esq.;Reed Smith LLP, 2500 One Liberty Place, 1650 Market Street, Philadelphia, PA, 19103, US

(73) Assignee: INSPIRED GAMING [UK] LIMITED, Burton on Trent, Staffordshire (GB)

(21) Appl. No.: 12/224,963

(22) PCT Filed: Mar. 12, 2007
(86) PCT No.: PCT/GB2007/000815

§ 371 Date: Sep. 18, 2009

(30) Foreign Application Priority Data
Mar. 11, 2006 (GB) 0604943.1

(51) Int. Cl. G06Q 20/00; G06Q 40/00; G06Q 50/00; G06F 9/46; G06F 11/07

(52) U.S. Cl. 705/41; 719/313; 714/48; 714/E11.025

(57) ABSTRACT

Pay to play entertainment machines or devices for gaming, gambling and other entertainment functions used in public spaces such as bars, clubs etc are networked and centrally controlled. Each entertainment device has at least one payment mechanism such as a coin acceptor or a card reader. Content executables (e.g. games) are configured to use a set of generic payment instruction messages to communicate with the payment mechanisms. A credit handler module translates generic payment instruction messages to and from specific payment functionality messages as used by the different payment mechanisms and also applies any transaction processing logic that is required consequent on the particular domain of operation of the entertainment device, e.g. legal requirements. Thus, locally applicable requirements relating to credit handling operations in the real and virtual environment of the entertainment device can be implemented without modifying content executables.

The present invention relates to networked entertainment devices and in particular to entertainment machines or devices incorporating some form of payment mechanism for use in public spaces such as bars, clubs, pubs, arcades and the like. Examples of such networked entertainment devices include video and/or audio jukeboxes, gambling machines such as slot machines including so-called ‘one-armed bandits’ and playing card game based systems, automated betting systems for both real and virtual events, video gaming machines and general arcade games.

There are a large number of different types of coin, token and card operated entertainment devices in the public space. Each type of device can have significantly different properties, in terms of the entertainment functions provided, the entertainment content available for display and use, and the permissible rules of operation of the machine. There has recently been a trend towards providing multi-function machines in which software and firmware can be configured on generic processor-based machines in order to provide a range of different possibilities for the type of entertainment content being offered. This enables common hardware to be used in many different environments, configured to provide entertainment content according to local requirements, legislation etc. This also enables entertainment content to be updated more readily as business requirements and popularity of entertainment content change.

For example, in a common application, a slot machine may provide an assortment of arcade games, quiz games and gambling games. Some of the entertainment content may be universal, i.e. provided on all machines of that type, while some may be selected by the manager of the premises in which the machine is operated. Some of the entertainment content may be admissible only during certain hours of the day, e.g. in the case of family pubs. The slot machine may be configured to display advertising material while in a standby mode of operation or during game play. The slot machine may be configured to display information related to local activities or events such as a happy hour drink offer or pub quiz. The local environment in which a machine operates, both real (e.g. physical and geographical location) and virtual (e.g. legislative and business environment) will collectively be referred to in this specification as the domain of operation.

There has also recently been a trend towards networking entertainment devices so that they can, to some extent, be controlled, configured and/or monitored remotely over the public telecommunications network. For example, it is now well-known for jukebox systems to routinely download new audio and video content from a central server as new content is released and becomes popular.

A problem with configuration of generic entertainment devices is the complexity of the task of ensuring that each device controlled within a large network is configured, maintained and operated in an appropriate manner for its current domain of operation. As suggested above, there are often a very large number of competing requirements that must be taken into account.

For example, the owner or operator of such entertainment devices may require specific controls in respect of entertainment content, pricing, advertising content etc, while allowing the local business (e.g. pub) in whose premises the device resides some flexibility in determining content which is locally popular, relevant to local trade, or useful in specific promotions. Furthermore, third parties such as licensees, sponsors, etc may have an interest in ensuring that advertising content appears in association with relevant entertainment content and possibly also at specific times and in specific formats. Furthermore, strict legislation controlling the use of entertainment devices is often determined on both a national and a regional level, as well as being specific to the type of premises in which the device is being operated and the type of entertainment content being offered. For example, legislation may govern both the type of entertainment content (e.g. gambling or game play) as well as the functionality (amount of payout or form of payout). Thus, ensuring that each entertainment machine in a large distributed network of machines is configured to operate correctly is a difficult task usually requiring complex preparation prior to installation and on-site service visits to configure and reconfigure machines.

A particular problem associated with the configuring of entertainment devices to use varying entertainment content is that the entertainment content loaded onto the entertainment device must correctly interface with any credit handling equipment on that device. Entertainment devices may have one or more of many different types of credit handling device (‘credit handler’) for pay in and pay out operations, such as coin and token acceptors, bank note readers, credit and smart card readers and coin hoppers. Each type of credit handler may have different properties and capabilities. Furthermore, as mentioned above, the domain of operation of the entertainment device may also influence the allowable operations that can be carried out by the credit handler. It is a time consuming, expensive and error prone activity to ensure that entertainment content provided to entertainment devices is correctly modified and/or configured for working with the credit handlers and domains of operation of the entertainment devices for which it is destined.

It would be highly desirable for entertainment devices to be managed centrally from a central or distributed control server in a manner that ensures that all machines in the network are configured correctly for their domain of operation. It would also be highly desirable for each networked entertainment device to be remotely monitorable to verify its present configuration. It would also be highly desirable to be able to remotely control the configuration of each machine. It would also be highly desirable to provide for expedient delivery of event messages generated by different entertainment devices to appropriate entities according to the type of event message. It would also be highly desirable for the relationship between entertainment content and credit handlers on entertainment devices to be automatically controlled.

It is an object of the present invention to provide an improved entertainment device which overcomes some or all of the problems associated with prior art devices.

According to one aspect, the present invention provides an entertainment device comprising:
a processor module;
one or more peripheral payment mechanisms;
an entertainment content handler and content interface executing on the processor module for executing entertainment content;
a credit handler module adapted for interfacing between the one or more peripheral payment mechanisms and the content handler to implement payment in and payment out functionality, the credit handler module comprising

(i) a first interface for communicating generic payment instruction messages to and from the content handler, said generic payment instruction messages being non-specific to plural types of payment mechanisms,

(ii) translation module for translating said generic payment instruction messages to and from specific payment functionality messages, said specific payment functionality messages being specific to each of said one or more peripheral payment mechanisms, and

(iii) a second interface for communicating said specific payment functionality messages to and from said one or more peripheral payment mechanisms.

According to another aspect, the present invention provides a method of operating an entertainment device having an entertainment content handler executing entertainment content and one or more peripheral payment mechanisms, the method comprising:
generating generic payment instruction messages in the content handler, said generic payment instruction messages being non-specific to said one or more payment mechanisms;
translating said generic payment instruction messages to specific payment functionality messages in a credit handler module, said specific payment functionality messages being specific to each of said one or more peripheral payment mechanisms;
communicating said specific payment functionality messages to said one or more peripheral payment mechanisms to implement payment in and payment out functionality;
generating specific payment functionality messages in the one or more peripheral payment mechanisms;
translating said specific payment functionality messages to generic payment instruction messages in the credit handler module; and
communicating said generic payment instruction messages to said content handler.

Embodiments of the present invention will now be described by way of example and with reference to the accompanying drawings in which:

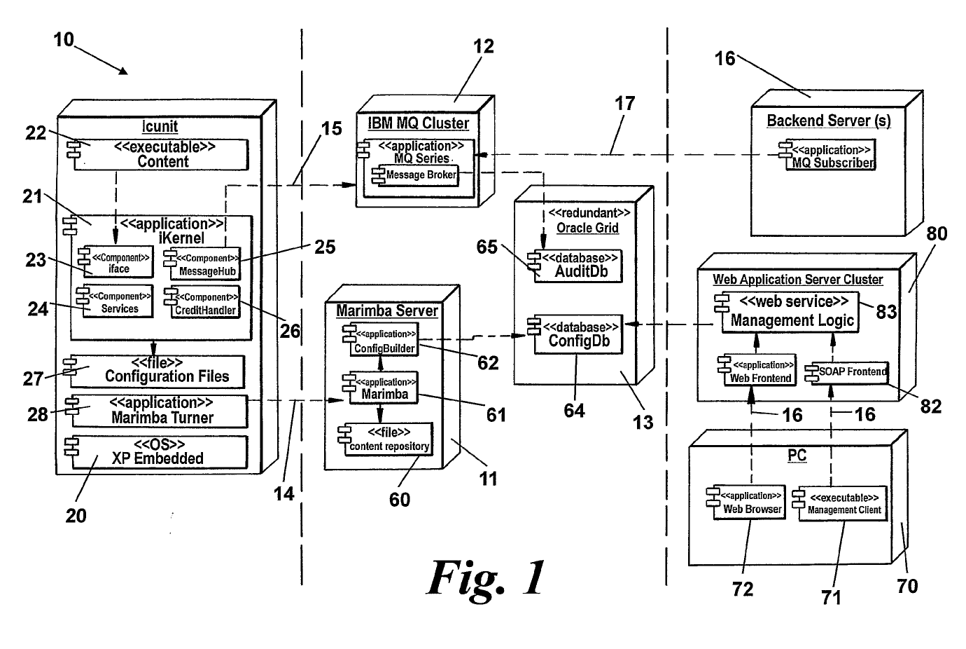

FIG. 1 is a schematic overview of a networked entertainment device and control system;

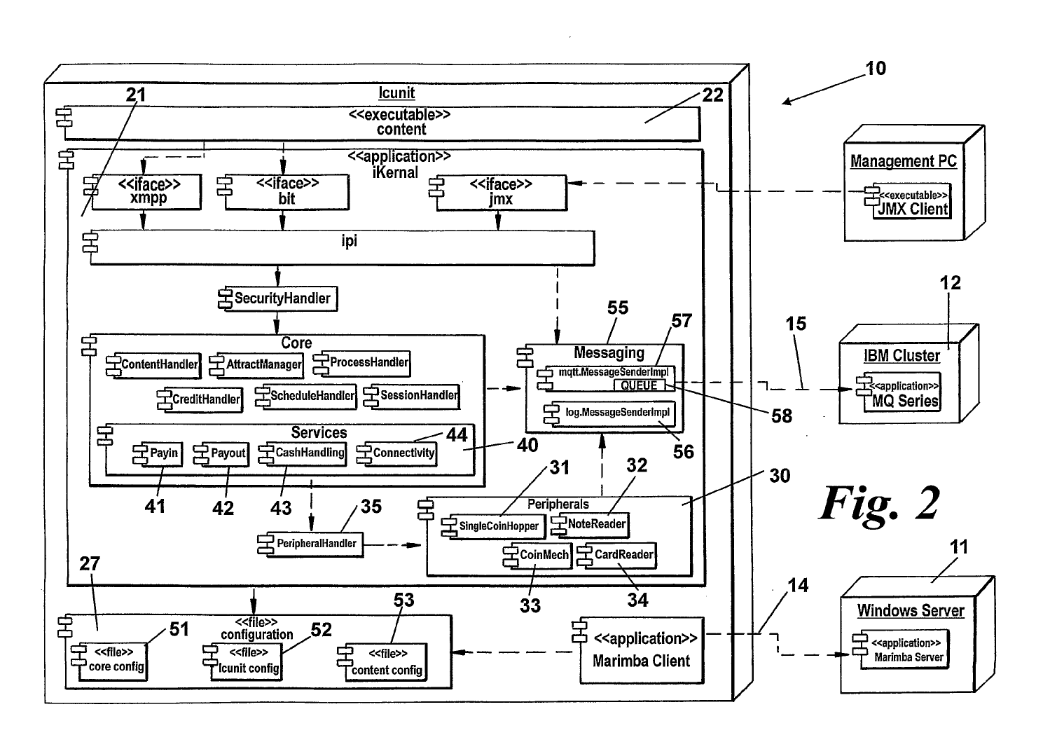

FIG. 2 is a detailed schematic diagram of the entertainment device and server of FIG. 1;

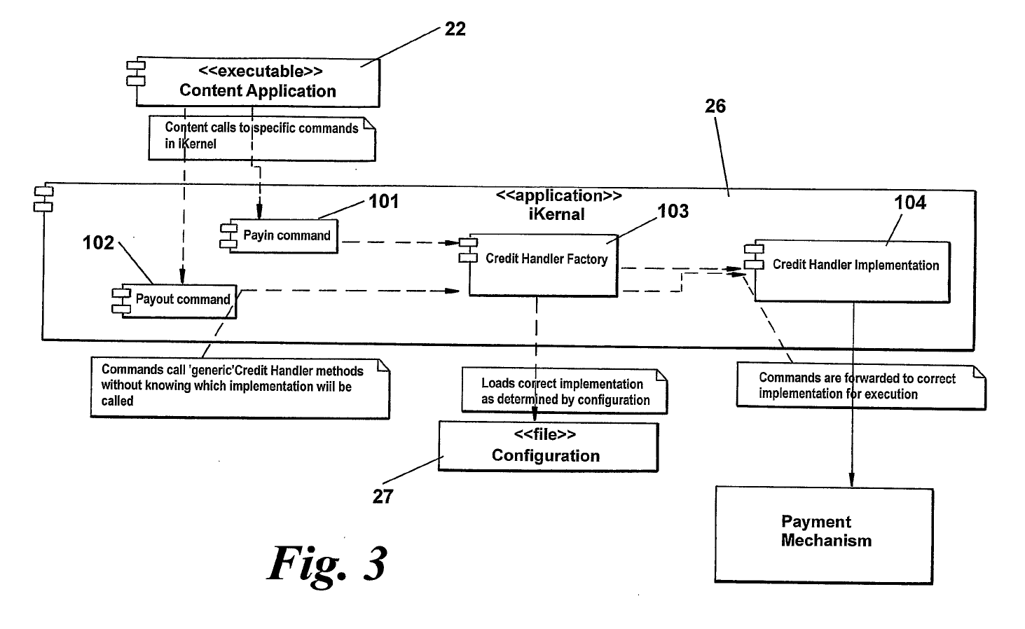

FIG. 3 is a detailed schematic diagram of a part of the entertainment device of FIG. 2 showing aspects of a credit handling facility; and

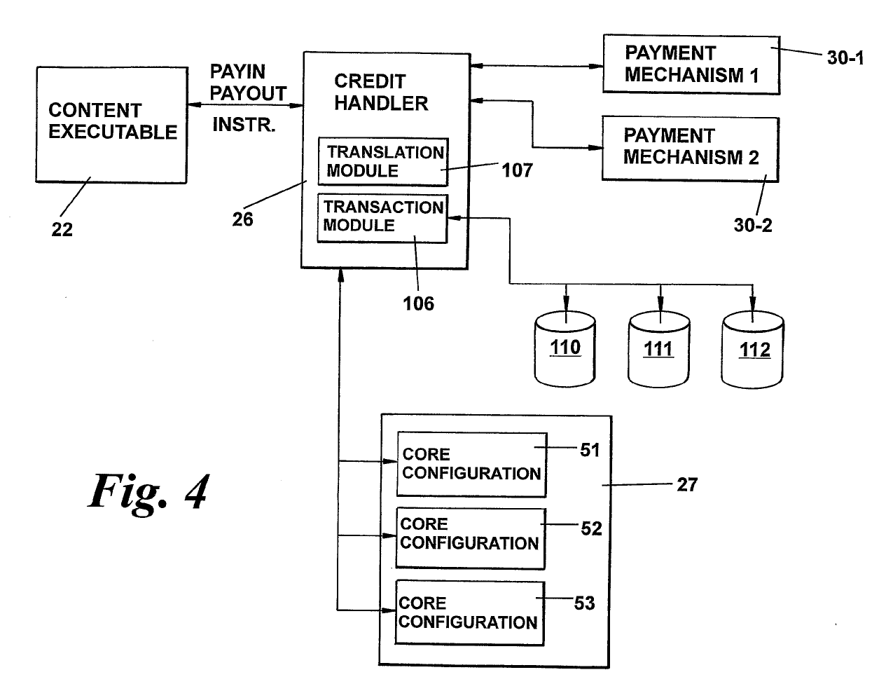

FIG. 4 is a schematic diagram illustrating a credit handling implementation.

Throughout the present specification, the expression ‘entertainment device’ is used to encompass all forms of ‘pay-to-play’ type machines including gaming machines, gambling machines, audio and video jukeboxes and any other machine adapted to provide digital data content to a user in return for payment via a payment mechanism. Thus, the expression ‘entertainment device’ may also encompass a machine adapted to deliver digital entertainment content (such as audio or video data) directly to a user device, such as an MP3 player.

The digital content delivered to the user may be of the form of an interactive program requiring continuous or periodic input from the user (e.g. a game or a quiz) via a user interface (e.g. keyboard, button set, touch screen, control console etc) or may be a non-interactive program requiring no input from the user once the program is initiated (e.g. the playing of music, a movie clip, advertising or other display content). More generally, the program which runs on the entertainment device to deliver digital content may be referred to herein as ‘payload’.

The expression ‘payment mechanism’ is intended to encompass any form of physical and/or electronic payment mechanism receiving from the user a form of payment token including any one or more of a coin acceptor mechanism, a banknote reader, a credit card reader, a credit token, a proprietary card reader and the like.

FIG. 1 shows an overview of an exemplary networked entertainment device. One entertainment device 10 is shown, connected to a control server 11, a messaging server 12 and a supporting database 13, over network connections 14, 15. It will be understood that many hundreds or thousands of entertainment devices 10 may be connected to the network 14, 15 using any convenient telecommunications network such as the public telephone network, leased private lines or the internet. It will also be understood that the functions of the server 11 and messaging server 12 may be provided by multiple servers, e.g. distributed around a network or provided by a hierarchical network of smaller servers.

Each entertainment device 10 is preferably based on a generic processor running a suitable operating system 20, e.g. Windows XP™ Embedded. Each entertainment device 10 includes a kernel process 21 executable on the operating system for managing content 22, controlling peripherals and communication on the device 10.

The entertainment device 10 includes a plurality of different content executables 22, each relating to a different entertainment content item. A content item may be any item of pay-to-play content, e.g. a game, a quiz, a music player or music track to be played thereon, a video player or video sequence to be played thereon, as well as any advertisement or display sequence to attract attention to the device, a menu for presentation of options to a user, or any executable causing output or transfer of digital content from the entertainment device as a service to the user. As discussed above, the content executables 22 may be referred to as payload.

The kernel process 21 preferably includes a set of components such as: content interfaces 23 which the content executables 22 use to connect to the kernel process 21; service components 24 for providing functions such as paying in, paying out, cash handling and connectivity; a message hub 25 for distributing event messages created within the device 10, e.g. relating to payments in, payment out, play counts, error messages, alarms etc; and other functional components 26 e.g. a credit handler, as will be explained in greater detail later. One content interface 23 may connect to many different content executables 22, and each content interface 23 may support one or more different types of content executable 22.

With reference to FIG. 2, each entertainment device 10 has a plurality of different peripherals 30 specific to its function. These may include, for example, a display output, an audio and/or video output, a user input console, and payment in and payment out mechanisms such as a single coin hopper 31, a banknote reader 32, a coin acceptor 33, and a card reader 34. Other peripherals may be used to model and control more abstract functions, for example connectivity to the network or the current build of the operating system. Each peripheral 30 implements a certain type of functionality or behaviour.

In one aspect, the peripherals 30 comprise all of the non-standard hardware items attached to or integrated into an entertainment device 10. Each peripheral 30 supports a set of functions, e.g. a single coin hopper is a coin hopper which dispenses a single denomination of coin only, and allows for commands like ‘Payout 25 coins’. Services are abstractions of the functions which types of peripherals provide: for example, a coin hopper provides the service ‘Payout’. In different environments, the same peripheral may provide different services. An example of this would be a card reader. In some environments, it may be possible to use an inserted card to take credit and to give credit to the customer—in these environments, the ‘CardReader’ peripheral 34 provides ‘Payin’ and ‘Payout’ services. In other environments, even using exactly the same card, it may only be used for one of those services. The decision as to which peripheral provides which services depends on the wishes of the operator of the entertainment device and may depend on the regulatory environment in which the device is located. The services provided by a peripheral may be entirely controlled through configuration.

As shown in FIG. 2, a peripheral handler 35 controls the set of loaded peripherals and monitors them for health. It will hand peripherals to appropriate services 40, but only as directed by configuration files. Exemplary services include ‘Payin’ service 41, ‘Payout’ service 42, ‘CashHandling’ service 43 and ‘Connectivity’ service 44. If a peripheral 30 becomes unavailable, the peripheral handler 35 will notify all the services which have previously received it. Each service is able to determine whether it is available at any time, given the current state of the entertainment device and the peripherals which are attached and available.

The configuration of the device 10 with respect to the hardware, firmware and software functionality of the device is stored in a configuration database 27 containing a number of configuration files. These may usefully be divided into: core configuration files 51 relating to the configuration of the kernel process and operating system; location-specific configuration files 52 relating to the location and ownership of the entertainment device 10; and content configuration files 53 relating to the configuration of content items 22.

Each content item 22 has a ‘content service type’ which indicates a set of services which must be available on an entertainment device 10 in order for the content item to function properly. It will be evident that a gambling game with cash prizes will need both Payin and Payout services available in order to function. A motor racing game may require specific user console services but will not require Payout services. A video jukebox content item will require specific video and audio output peripherals.

The configuration database 27 is used by the kernel process to establish exactly what services and functionality are available at any given time on the entertainment device 10 and this is used to determine what content is offered to the user. This means that, even if a particular peripheral should fail within the entertainment device, the device is capable of reconfiguring the menu options available to a user to maintain functionality of the device. The menu can simply offer a reduced choice. When the peripheral service becomes available again, then the menu can be modified back to the full range of content again.

Each entertainment device 10 is adapted to operate in a particular domain of operation, which domain defines both physical and virtual environment constraints as defined earlier. For example, the domain of operation may be a public bar which is (i) run by a local management, (ii) owned by a specific brewery, (iii) in a relationship with certain advertisers, (iv) targeting family clientele during the daytime and adult clientele in the evenings, (v) operating under local authority licensing regulations and (vi) operating under national licensing and gaming laws.

It will be understood that each of these six factors in the domain of operation may influence the way in which the entertainment device is to be operated. Generally speaking, a significant number of such factors determine the allowable or preferred attributes of the entertainment device. The expression ‘attributes’ is intended to encompass the content items or ‘payload’ available on a device, and the mode of operation of those content items. The expression ‘mode of operation’ is intended to encompass rules governing the way in which the content is delivered, restrictions on its input/output parameters and restrictions on the services available to the content.

For example: (i) the pub owner, or brewery may wish to dictate that a certain range of promotional games and offers are available; (ii) the local landlord may recognise that certain games are locally more popular than others and prefer that these are presented with a higher profile; (iii) local management may wish to introduce special offers in conjunction with content delivered by the entertainment device, e.g. an offer to “play game X to win a pint of guest ale”; (iv) a contract between the brewery and another commercial organisation may dictate that predetermined advertising material should appear on the entertainment device display for predetermined periods of time, e.g. when the device is in an idle mode, or even during content item delivery; (v) legislation, regulation or operator preferences may stipulate that certain video or audio jukebox material is not available during the day while families are using the pub; and (vi) gaming laws may dictate certain payout restrictions, possibly at different times of the day.

In prior art systems, it has proved impossible or complex and expensive to configure and reconfigure entertainment devices to meet ever changing requirements for the content offered on the device menu, and the way in which that content executes on the device.

In a preferred embodiment, each entertainment device 10 is assigned to belong to one or more ‘groups’ of such devices 10. Each group has an associated schedule that defines a set of attributes (e.g. content, mode of operation) for all the devices belonging to that group. Those attributes in the schedule may include desired attributes in an order of preference and may include mandatory attributes to comply with regulations.

For example, one schedule may relate to use of an entertainment device in a public bar. Another schedule may relate to use of an entertainment device in a betting shop, and another to use in a casino. Each will have different preferences for content items and different regulations as to content items and mode of operation (e.g. payout criteria). Further schedules are then added for specific domains of operation which will influence the attributes of the devices in certain contexts. For example, a device may belong to seven different groups each influencing the desired or mandatory attributes of the device in its domain of operation, consisting of the groups: (i) public bar; (ii) UK gaming legislation; (iii) city centre pub in Coventry; (iv) family access up to 7 pm; no under eighteen access after 7 pm; (v) owned by ‘brewery1’; (vi) run by ‘managementco3’; (vii) advertising agreement with ‘advertiser2’ etc. Each group may have its own schedule defining a set of attributes for operation of an entertainment device. Each attribute listed in the schedule carries an importance weighting, preferably on a numeric scale.

In a simple exemplary arrangement, let us suppose there is a first schedule indicating a menu for a generic pub entertainment device, with importance weighting in brackets:
Entertainment Menu (30)
Game1 (20)
Game2 (40)
Game3 (15)
AdultGame1 (35)
AdultGame2 (10)

Next, suppose there are some special promotional games for ‘Brewery1’, who own the pub. A customised menu and modified games are required for this brewer. The Brewery1 special schedule looks like:
Brewery1_SpecialMenu (35)
Game3 (15) (mode=Brewery1)
Brewery1_SpecialGame1 (35)

Now, we have a ‘Non-offensive’ schedule. Instead of adding games, this will remove anything that is a bit rude:
AdultGame2 (5) (excluded=true)
AdultGame3 (10) (excluded=true)

In other words, attributes that are determined by a schedule may be ‘negative’ attributes, i.e. the schedule enforces inhibition or removal of some existing functionality.

Lastly, we have signed up with Advertiser1 to do a drink promotion in pubs in the Coventry area, and are rang an application to manage this:
Advertiser1_payload (50)

Each of these schedules is associated with an appropriate group of machines.

For an entertainment device installed in a family-oriented Brewery1 pub in Coventry, firstly it will launch Brewery1_SpecialMenu (35) since that is the menu with the highest importance weighting. Secondly, that menu will contain, in order, by importance weighting:
Advertiser1_payload (50)
Game2 (40)
Brewery1_SpecialGame1 (35)
AdultGame1 (35)
Game1 (20)
Game3 (15) (mode=Brewery1)

Thus, the combined schedules associated with the particular group membership of the entertainment device have determined both a set of content available to a user of the device, and modes of operation of that device.

It will be understood that mandatory attributes, such as those required in order to comply with legislation, can be given importance weighting values which are not overridable by other elements in schedules. These may be represented by Boolean variables governing the mode of operation of a content item.

Optional schedules may be generated for other users to select from. For example, a pub landlord may be permitted to select from several possible ‘Landlord’s Choice’ schedules, which will influence the other schedules according to the choice of additional schedule made by the landlord. Access to modify selected schedules can be restricted according to the privileges granted to each user.

In a further example, schedules may be divided into two types, primary schedules and modifying schedules. In the example above, the schedules given are primary schedules. Other persons or organisations involved in operating the entertainment units may be given access rights to introduce modifying schedules.

A modifying schedule is adapted to add or subtract an importance weighting value to or from the importance weighting established by the cumulative primary schedules. So, extending the pub example above, a modifying schedule may assert the following modifying importance weightings:
Advertiser1_SpecialMenu (−5)
Game2 (−5)
Brewery1_SpecialGame1 (+5)
AdultGame1 (−10)
Game1 (+0)
Game3 (+10) (mode=Brewery1)

The final determined attributes for the entertainment device would then be:
Advertiser1_Payload (45)
Brewery1_SpecialGame1 (40)
Game2 (35)
AdultGame1 (25)
Game3 (25) (mode=Brewery1)
Game1 (20)

The maximum variance of importance weighting allowed by a modifying schedule may be governed by user access privileges. Modifying schedules may be implemented and adjusted automatically according to a predetermined algorithm driven by input parameters such as number of times the game is played, scores achieved, profit on the content or any other parameter or combination of parameters. Thus, an optimisation engine may be implemented for maximising profit from available content, subject to constraints imposed by primary schedules.

Schedules may be activated only for predetermined periods. Thus, a schedule may be configured to prevail only during certain hours of the day. In a preferred embodiment, each schedule includes a ‘TimePeriod’ field, which may have values indicating that the schedule is active on certain days of the week, certain hours of the day or ‘always’. The activation of the schedule may relate to the schedule as a whole, or to only certain items within the schedule. Thus, in a general sense, the schedules include a time period which indicates the temporal validity or activation of the schedule or of one or more attributes defined in the schedule.

This feature is useful for controlling entertainment content during different hours of the day, but can also be used to vary the price of pay-to-play items throughout the day or week. For example, the content ‘Game2’ could be made more expensive on weekend evenings in all relevant pubs, by adding parameters to the appropriate schedule entry so that the schedule applies 18:00-24:00 Sat Sun, and the entry ‘Game2 (40)’ has a parameter (cost=2.00). Although the importance weighting is unchanged (and therefore the menu order is unchanged), the cost is non-default and the cost parameter in the schedule takes precedence. In another example, certain pubs within a chain could be targeted with selected premium content at certain times of the day.

Schedules may determine other modes of operation for each content item. Generally, these modes could include currency and credit details on the device, language of operation, type of graphics used etc.

The schedules may not only define content items, modes of operation for those content items and menu contents, but also may be used to control layout of content including menus displayed on the entertainment device. Thus, the schedules may determine layout, size and position of control buttons and items on the display. Weighting values may be used to determine which preferred layout will prevail. The layout may determine the number of menu buttons available, the relative sizes of the buttons and their positions on a display independent of the content that will eventually be ascribed to each button, as determined according to all the schedules as discussed above.

The entertainment devices 10 may be configured to use the schedules and weighting values in each relevant schedule in order to ensure that only the top n content items are offered to the user, if it is desired to place strict limits on the total number of items in a menu at any one time. Thus, if the cumulative schedules for a device imply a total of thirty content items, in order of importance, but the device may offer only twenty at any one time, then the device will display only the top twenty according to importance weighting. Should any function of the device become impaired (e.g. loss of a service 40) which would eliminate several content items from availability, other schedule items can be moved up into the available menu. Alternatively, the number of content items offered may be unrestricted according to the total number suggested by the schedules.

Control of the mode of operation of each entertainment device can be implemented entirely remotely by one or more authorised users using appropriate remote interfaces as will now be illustrated (although this does not exclude the possibility also of control at the device itself).

Preferably, the operating system 20 and kernel process 21 are pre-installed in the device 10 and generally remain unchanging, although it will be understood that software upgrades could be delivered over the network 14. Hardware peripherals 30 and associated services 40 are also preferably pre-installed and remain unchanging, although preferably these are modular items that can be swapped by service visits to the device. Different content items 22 and configuration data are delivered to the devices according to the schedules in the following manner.

With further reference to FIG. 1, a content repository 60 is located in server 11 and maintains a structured list of all content items available, including version information if required to ensure that content item compatibility with each entertainment device 10 can be established. The content repository 60 includes content item executables for transfer to entertainment devices 10 or pointers to where to obtain that content elsewhere, if the content items are not already installed on the entertainment devices 10. A data transfer server 61 in server 11 communicates with a corresponding data transfer client 28 in the entertainment device 10 for transfer of content items 22, schedules and configuration files 27. A configuration builder application 62 builds configuration files for transfer to the entertainment devices 10. The configuration data is provided from a suitable configuration database 64 in supporting database server 13. The configuration data in configuration database 64 includes one or more schedules for each group of devices 10 as discussed previously.

One or more management user interfaces or management computers 70 are in communication with a management server 80 over a suitable network connection 16, e.g. the internet. In one embodiment, the management user interface executable 71 resides on the management computer 70 and interacts with the management server 80 via SOAP 82. In another embodiment, access to the management server 80 may be via a web browser 72 installed on the management computer 70 which communicates with a web application 81 to manipulate this data. Management logic 83 in the management server 80 updates the schedules in configuration database 64.

Different management users may implement different schedules within the configuration database 64 via the management server 80 according to individual user privileges. In a simple embodiment, one management user could implement all schedules for all groups of entertainment devices throughout the network. So, for example, the management user establishes a plurality of schedules, each schedule corresponding to a particular domain of operation of entertainment devices as discussed earlier. There may be hundreds of available schedules, each corresponding to a different type of entertainment venue; legislative environment, business environment etc. In a general sense, each schedule defines a set of attributes for operation of an entertainment device.

In use, an entertainment device 10 is installed in a domain of operation and is given a particular unique identification tag. The management user establishes which schedules are applicable to this device according to its domain of operation and, using the management interface 70, associates that entertainment device with appropriate ones of the available schedules. In practice, each schedule is associated with a group of devices having at least one set of common required or preferred attributes.

Using the data transfer client 28, the installed device 10 establishes communication with the data transfer server 61. Using configuration builder 62, server 61 queries the configuration database 64 and acquires the relevant schedules associated with the installed device 10. The schedules may then be transferred to the entertainment device for use by the installed device 10 to establish its local configuration. Alternatively, and more preferably, the schedules are used to generate required configuration data for the installed device 10 and deliver that configuration data to the device for updating configuration files 27. All the schedules that apply to the installed device are used to determine a subset of attributes that shall prevail in that device. It will be understood that those attributes may include menu items for display to users, content items or ‘payload’ available on the device, and the mode of operation of those content items, as previously discussed.

The kernel process 21 uses the configuration data to retrieve content items 22 either from its own local storage, from remote storage such as content repository 60, or from any other location determined according to the configuration data. The kernel process then displays or otherwise implements a menu selection according to the prevailing attributes as determined by the schedules.

It will be understood that different schedules may be imposed by different management users, as illustrated in the examples above. The owner of a venue in which entertainment devices are installed may define his or her own schedules to determine the games and other content that are generally available. These may be supplemented by schedules provided by the supplier of entertainment devices to ensure compliance with local and national regulations. An advertiser may be permitted access to implement schedules that affect certain devices. The local management of the venue may also be permitted to implement schedules to locally vary content according to local tastes or special promotions.

By controlling the range of possible importance weightings, or limits on the magnitude of importance weightings in modifying schedules, it is possible to ensure that each management entity has only the appropriate level of influence over the attributes of a given group of devices.

By carefully controlling access privileges to the schedules for groups of devices, it is possible to ensure that only authorised persons can influence designated attributes of the entertainment devices. For example, schedules that influence legally significant attributes of the devices may be inaccessible to all users except those responsible for legal compliance, and such attributes may be weighted so that they cannot be overruled or influenced by other schedules.

Changes to the schedules during routine use of the networked devices could be implemented on a periodic routine update basis or be forced through in an immediate update process. For example, devices 10 may be configured to periodically check their configuration schedules by connecting with control server 11 on a daily or hourly basis. Non-critical updates requiring significant downloads of new content could be implemented in off-peak hours. Critical updates could be forced by communication with the device 10 being initiated by control server 11. This strategy allows for better use of restricted bandwidth network communications.

The entertainment devices are able to run semi-autonomously in the event of periods of non-availability of the network 14 or some services 40 on the device itself. The importance weighting of menu items in schedules allows the device to adapt to implement content only as and when it and the supporting services are available. Thus, the kernel process 21 is preferably adapted to offer only content items that meet three criteria: a) it is content that is scheduled for that device, b) it is content which is currently available on/downloaded to that device, and c) it is content which is currently fully supported by peripherals and services on that device.

It will be recognised from the above description that the invention offers a powerful and effective tool for remotely controlling the content offered, mode of operation of, and other attributes of, a large number of entertainment devices in a network, according to a complex set of fixed and variable requirements, by a large number of management users.

Another important aspect of maintaining a network of entertainment devices 10 is the function of event reporting and, more generally, event handling. During operation of an entertainment device 10, numerous different events occur which it may be desirable, essential or legally mandatory to record and/or notify to an appropriate entity. The appropriate entity to which an event should be notified may vary, for example according to: (i) the type of event; (ii) the owner, operator or administrator of the machine or of certain functions of the machine (e.g. cash handling maintenance, etc). (iii) the physical or geographical location of the device, etc. More generally, the domain of operation may also determine the manner in which event messages should be handled.

Events that should be recorded may include any significant interaction with a user. The user in this context may be a customer, manager, installation engineer, service engineer, cash collection agent etc. The events to be recorded may include identity of games played, payloads executed, the times and amounts of payout events and payin events, cash floats maintained, errors reported by software and/or hardware relating to peripherals and/or content, changes in menus, payloads etc, and completed status of downloads. Events that generate messages generally include changes in the virtual or physical condition of the entertainment device.

More generally, the event recordal process ideally should enable the precise current and/or historic configuration of a device to be confirmed at any given time.

For entertainment devices handling cash, it is desirable that the state of the bank within the machine is known at any given time. For credit-based machines, it is desirable that credit transactions are passed to the relevant credit handling entity at reasonable intervals, and that credit authorisation requests are handled immediately. For juke box type machines, it is desirable that the number of times an audio or video content item is played is accurately and verifiably recorded for the purposes of copyright royalty payments and the like. For routine and critical error events, it is desirable that service personnel are notified in a timely manner according to the criticality of the error.

With further reference to FIGS. 1 and 2, various elements in the entertainment device are capable of initiating event messages that indicate an activity, status or outcome in the entertainment device. For example, the kernel process 21 may initiate event messages relating to the running of certain payloads or content executables 22, or to the updating of configuration files 51, 52, 53 in the configuration database 27. The peripherals 30 or peripheral handler 35 may initiate event messages relating to payin and payout events, hardware status, faults etc. The entertainment device 10 may also have hardwired and/or software detection systems (not shown) triggered by physical events such as an attack on a machine, or an authorised opening of a cash box to remove or replenish cash. The data transfer client 28 may also initiate event messages relating to opening and closing of network connections to the control server 11 and messaging server 12, and logging downloads/updates from the control server 11. The kernel process 21 may also initiate event messages relating to different users logging into the entertainment device, e.g. management or service users accessing special menus or service options on the device 10. More generally, the event messages may represent any physical and/or virtual event that occurs in the entertainment device 10.

Each event message initiated is sent to the message hub 25 (FIG. 1). As shown in more detail in FIG. 2, message hub 25 includes a messaging module 55. In one implementation, the messaging module 55 includes a messaging component 56 which simply writes a local log file (e.g. in the entertainment device 10) for subsequent debug. The messaging module 55 is also adapted to prepare and transmit event messages to an external entity, such as a data centre. In this respect, the messaging module 55 includes a transmit module 57 which transmits event messages to the remote messaging server 12 over network connection 15. The transmit module 57 includes a message queue 58 to be described later.

Message preparation may include packaging the messages into a standard format and include such generic functions as attaching a source address field and a destination address field. Each event message includes an event type (such as ‘cash transaction’, ‘game play’, ‘bank status’ etc. The event types may be arranged in a hierarchical manner to help organise them. Each event message may include a number of information fields giving one or more event value, e.g. a numeric, text or logical state to the event. If the events are arranged hierarchically, any event may have all the attributes of its parent event. Each message is allocated a priority level, which might be explicitly indicated in a priority field of the message, or might be inferred from the event type and/or event value.

In a simple embodiment, only two priority levels might be used. A first priority level indicates that the event message is time critical and should be sent to the message server 12 at the soonest opportunity, e.g. immediately that a network connection 15 becomes available. If a network connection is not presently available, then a first priority level message would indicate that a connection should be established. A second priority level indicates that the message is not time critical (or is less time critical) and need not be sent immediately. Generally, the first priority level event message is referred to herein as having an ‘immediate-send’ or ‘send now’ status, while the second priority level event message is referred to herein as having a ‘non-immediate-send’ or ‘send later’ status.

An important consideration in maintaining a large number of networked entertainment devices 10 is that of communication bandwidth. To maintain permanently open or available communication channels between devices 10 and messaging server(s) 12 may be prohibitively expensive. The messaging module 55 therefore preferably uses the message queue 58 to store event messages that have ‘non-immediate-send’ status. Various triggers may be used to determine when to send queued messages to the messaging server 12. For example, all queued messages, or as many as will fit into a standard transmission packet or chain of messages, may be transmitted periodically. This periodic transmission may be any suitable type, such as (i) as soon as the queue reaches a predetermined length; (ii) as soon as the oldest message in the queue has reached a predetermined age; (iii) as soon as any message in the queue has reached a critical age; or (iv) fixed time, such as every hour, or any combination thereof. Alternatively, or in addition, queued messages may be transmitted whenever an ‘immediate-send’ message arrives, forcing a transmission to the messaging server.

Such an event message sending strategy optimses use of the communications network while maintaining real time transfer of critical data.

It will be understood that more priority levels may be used in the ‘non-immediate-send’ status category. For example, event messages may be given a maximum delay period for transmission to the messaging server. This feature is useful if it must be guaranteed that certain types of status data on the entertainment devices is never more than a predetermined period out of date. It will be understood that messages of the ‘immediate send’ status are sent as soon as possible, i.e. as soon as a communication channel to the messaging server 12 is available. Preferably, this would be practically immediate, but otherwise is intended to mean as soon as a communication channel becomes available.

The message log 56 may be used in a number of different possible ways. For example, it may maintain a permanent or semi-permanent record of event messages or their headers, or may delete event messages after a predetermined time or in response to a user instruction. The message log may store event messages only until receipt has been confirmed by the message server 12. In another arrangement, the queue 58 may reside in the message log, e.g. by flagging unsent messages.

A feature of one preferred embodiment is that the entertainment devices 10 do not need any substantive message routing intelligence. The messaging module 55 is preferably required only to prepare and transmit messages to a message server 12 without knowledge of the ultimate intended recipient(s) of, or subscriber(s) to, the messages. In a preferred embodiment, the messaging server 12 is a message oriented middleware product, such as the IBM MQ series. Each entertainment device 10 may be regarded as a publisher of event messages. Each event message will have one or more subscribers authorised as recipient of the information in the event message. A function of the messaging server 12 is to distribute information from the event messages to relevant authorised subscribers or ‘subscriber entities’. A subscriber entity is depicted in FIG. 1 as a subscriber server 16, which may be any suitable communication device capable of receiving data from the messaging server 12. It will be understood that a large number of subscriber servers may be connected or connectable to the messaging server 12.

Each operator or owner of entertainment devices 10 may be a subscriber to the data from all event messages originating from its respective entertainment devices. A device servicing organisation may be a subscriber to the data from all event messages relating to operational condition of hardware from entertainment devices for which it is responsible. A cash handling or credit handling organisation may be a subscriber to the data from all event messages relating to cash or credit transactions. A regulatory authority or other control body may be a subscriber to data from event messages which can be used to confirm compliance with rules governing use of the entertainment devices such as gambling regulations, amusements-with-prizes regulations, copyright control and royalty collection etc.

In a general aspect, the messaging server 12 is responsible for forwarding all event messages to the correct subscribers according to a classification of a message and/or according to an attribute of the message. The expression ‘message classification’ is intended to encompass a message source identity (e.g. the identity of the device 10 which originated the event message), a source location or domain of operation, a source group or schedule defining device attributes of such a group as previously defined. The expression ‘message attribute’ is intended to encompass event types and event values as previously discussed and may also include time and/or date of origin of the message as well as other content of the message. Thus, a subscriber may elect to receive only error messages from entertainment devices for which it is responsible, and the error status may be determined by either the event type being an error type, or the event value indicating an error, e.g. out of range. Preferably, the message server 12 maintains a profile in respect of each subscriber, which profile determines the messages forwarded to that subscriber.

Message classifications and attributes may be determined according to a hierarchical or tree structure of event messages in which child nodes inherit properties of a parent node. Subscribers may subscribe to certain branches of the message hierarchy, e.g. a node and all children of that node.

The forwarding of messages may take place in several possible ways. In a first arrangement, the messaging server 12 acts a ‘post office’ forwarding entire messages or selected message contents to intended subscribers. Destinations of the messages are determined by a subscription basis of the individual subscribers, i.e. determining which messages a subscriber is authorized to receive. A subscriber server 16 is then used to receive and store event message data as required. Thus, each subscriber receives a subset of the messages received by the messaging server 12.

In a second arrangement, the messaging server 12 may act as a repository for event messages from many devices 10. Individual subscribers 16 may then access event messages to which they are authorized subscribers (i.e. a subset of the received event messages or data) on demand from the messaging server. In this aspect, the forwarding of event messages is ‘on demand’. The expression ‘event messages’ is intended to cover the messages themselves or just the event information or data contained therein.

It will be recognised that a significant advantage in the arrangements of the messaging server as described above is that changes in subscribers to the messaging server can take place without any change in the software or other functionality of the individual entertainment devices. The expression ‘changes in subscribers’ is intended to encompass changes in the subscription basis of one or more subscriber entities, changes in the subscription profile of one or more subscriber entities and/or changes in the subscriber entities themselves including deletion or addition of subscriber entities.

The forwarding of event messages by the messaging server 12 to a subscriber server may operate on a similar basis to that which applies between the messaging module 55 and the messaging server 12, e.g. according to message priority levels corresponding to ‘immediate send’ status and ‘non-immediate-send’ status. The communication channel 17 between the messaging server 12 and subscriber servers 16 may be continuous or intermittent. The messaging server 12 preferably offers guaranteed delivery of messages, even where there is intermittent connectivity between the messaging server and the subscriber servers 16 and thus behaves as a persistent message server.

Although the principal recipient of event messages is the message server 12, the event messages generated by the messaging module 55 may be received or captured elsewhere. For example, a local network (e.g. within a pub or arcade) may have a local management computer system adapted to also receive some or all event messages from an entertainment device using a wired or wireless LAN. Such a local management computer system could include a venue cash management database for local cash flow control. In this aspect, the messaging module may be configured to multicast messages to two or more separate destination addresses. These messages may be in different formats and using different transport protocols. To implement this, the messaging module 55 may include more than one transmit module 57. Still further, the entertainment device 10 itself may monitor event messages and, if there is a predetermined period of inactivity in respect of certain types of event messages, may use this as a trigger to load a different content executable—e.g. a video sequence or different menu likely to attract more attention.

A significant advantage of the use of a message server is that requirements for use of the event messages may be expected to vary more rapidly than changes in the operation of the entertainment devices themselves. Altering software on the entertainment devices to change the rules governing generation, use and destination of event messages is problematic and high risk owing to the number of software modules that would have to be updated. Changing functionality at the message server is a simpler and more controllable task.

Another important aspect of configuring and maintaining entertainment devices is to ensure the correct operation of credit handling facilities on the entertainment device. Different types of payment mechanism offer very different mechanical and electronic functionality, and may also be used to implement very different methods of credit handling.

For example, a coin acceptor mechanism in conjunction with a coin hopper provides electromechanical functionality for receiving and verifying coins and paying out coins of specific denomination, provided that the coin bank has sufficient credit. A card reader may have mechanical and electronic functionality for reading a card type, reading available credit from the card, debiting an amount from that card, and crediting an amount to that card.

The credit handling facilities must not only be configured correctly for the type of payment mechanism available, but must also implement transaction processing logic that ensures that payment transactions are handled in accordance with the domain of operation of the entertainment device. For example, this may require maintenance of one or more credit banks. In a typical entertainment device environment, separate banks may be maintained for credit paid in, credit from promotions and credit from winnings. The transaction processing logic may also be dictated by local regulations. For example, in certain UK gaming rules, cash winnings from a betting game may not be used to stake on a game without an explicit transfer of funds from the ‘winnings’ bank to the ‘credit’ bank. Similarly, it may be required that accrued winnings on the entertainment device may not exceed a predetermined level without physically paying out those winnings. Other constraints may be required by the operator of the entertainment device, e.g. that credit from promotions must be used before credit from monies paid in, or vice versa or that credit from promotions may not be used for paying out, only for game play.

The present invention facilitates the separation or segregation of generic payment instruction messages as may be issued or received by an entertainment content handler (e.g. content executable 22 running through content interface 23 on kernel process 21) from specific payment functionality. This allows a content executable 22 to use a generic set of payment instruction commands regardless of the domain of operation of the entertainment device. It will be recalled that the domain of operation may refer to both physical attributes of the entertainment device such as its peripheral payment mechanisms, as well as virtual attributes such as the legislative and business environment.

The entertainment device 10 is provided with a credit handler module 26 that enables the content executable 22 running through content interface 23 on kernel process 21, to interface with payment mechanisms 30 via a common set of generic payment instruction messages.

FIG. 3 illustrates in more detail the credit handler module 26 of FIG. 1 and its relationship with content executable 22 and configuration database 27. Content executable 22 generates generic payment instruction messages such as ‘payin’ instruction 101 and ‘payout’ instruction 102. Each of these generic instruction messages may have other attributes such as ‘amount’. The expression ‘generic payment instruction message’ is used to indicate that the message 101, 102 is of a type that is not specific to any one type of peripheral payment mechanism 30, such as coin hopper 31, banknote reader 32, coin acceptor 33, card reader 34, or not specific to any transaction processing environment or domain of operation. Thus, in order to be implemented on a specific type of peripheral payment mechanism or in a specific domain of operation, the generic payment instruction message 101, 102 must be adapted, e.g. by implementation of one or more specific functions or additional logic.

A credit handling loader 103 determines a domain of operation by obtaining configuration data from the configuration database 27 that enables it to load or call an appropriate credit handler implementation 104. Generic payment instruction messages 101 or 102 are thus passed to an appropriate credit handling implementation 104 that applies, to the generic messages 101, 102, any transaction processing logic and translation of commands as required by the domain of operation of the entertainment device 10. The credit handler implementation thereby provides an interface to specific peripheral payment mechanisms 30, 31, 32, 33, 34. Each type of peripheral payment mechanism (e.g. card reader, coin acceptor) could use a separate credit handler implementation 104 to communicate specific payment functionality messages to and from the content executable 22. The expression ‘specific payment functionality message’ is used to indicate that the message is specific to a particular type of peripheral payment mechanism, e.g. a coin mechanism, card reader etc.

Each type of payment mechanism supports various types of transactions and requires a specific set of functions and commands relating to cash or credit handling according to the nature of the payment mechanism.

Turning now to FIG. 4, this illustrates in more detail the functions carried out by the credit handler implementation 104. Under control of a transaction module 106, the credit handler 26 maintains one or more banks 110, 111, 112 which indicate credit balances of various types. The banks 110-112 record credits of different types, which may include promotional credits (e.g. credit issued by the operator solely for play), pay-to-play cash credits (e.g. real cash paid by the player), winning credits (e.g. real cash won as a result of game play). The banks 110-112 may also record cash available for payouts in the machine, etc. For some payment mechanisms, distinctions may be made between credits provided by cash or by credit/debit card. Some, or all, of the banks 110-112 may be remotely located (i.e. not within the entertainment device 10) on, for example, a remote server. Such an arrangement may be desirable for security or other reasons. A suitable secure transmission protocol could be used for updating the banks 110-112. In another example, some or all of the banks may be stored, or duplicated, on a smart card or other media inserted by the user.

The credit handler 26 is coupled to one or more payment mechanisms 30-1, 30-2 as previously discussed. The credit handler 26 is preferably also coupled to core configuration file 51 relating to the configuration of the entertainment device 10, location-specific configuration file 52 relating to the domain of the entertainment device 10 and to content configuration file 53 relating to the content executables 22. From this information, the credit handler 26 determines how to execute generic payment instruction messages according to the domain of operation.

To do this, the credit handler 26 includes a translation module 107 for generally translating or converting generic payment instructions messages to and from specific payment functionality messages, specific to the payment mechanism in use. The credit handler 26 also includes the transaction processing module 106 that ensures that any payment transaction processing requirements dictated by the domain of operation are also implemented.

In an example of use, the content executable 22 requires a ‘payin’ transaction before the content can continue to execute. It issues a payin instruction to credit handler 26. Credit handler 26 determines, from the configuration database 27, any content configuration data 53 which may affect the transaction, and any location-specific data 52 that may affect the transaction. For example, credit handler 26 may determine, from this data, that only pay-to-play cash in a credit bank is eligible for this payin and determines whether such an amount is available for play. If it is, a transaction confirmed message may be returned to the content executable. If it is not, the credit handler may issue a suitable functionality message, e.g. causing a payment indicator to illuminate on a coin slot. The credit handler may then wait for confirmation of coin receipt and amount from the payment mechanism, credit the appropriate bank 110, and complete the transaction. Once, the transaction is completed, the credit handler may issue an appropriate generic payment instruction message to the content executable 22 to indicate that the required credit has been paid in.

In another example, the content executable 22 may issue a generic payout instruction. In this case, the credit handler 26 determines from which bank the payout is to be made and issues specific payment functionality messages to the appropriate payment mechanism 30. For example, if this payment mechanism is a card reader, instructions may be given to credit the card with the appropriate winning.

The provision of a translation module 107 that effects translation of generic payment instruction messages to and from specific payment functionality messages enables executable content to be provided and run without knowledge of the exact payment mechanisms that are available on an entertainment device. The provision of a transaction module 106 that effects transaction processing according to generic payment instruction messages and to domain specific parameters provides a significant advantage that executable content can be provided and run without knowledge of the legal and physical constraints placed on the payment mechanism and transactions therewith. This means that the code relating to payment in/payment out functionality for each content executable 22 is segregated from the content executable in such a way that transaction processing functionality can be readily switched to cover different legislative areas. In preferred embodiments, this could be effected remotely using similar configuration updating processes as previously described.

In the event that a content executable 22 attempts to perform a generic payment instruction that is incompatible either with the available payment mechanism hardware 30 or incompatible with the prevailing domain-specific transaction processing requirements, the credit handler 26 is adapted to return an appropriate error message or exception to the content executable. Examples of error conditions triggering such error messages could be peripheral payment mechanism failure, inadequate bank balance, legal non-compliance with the domain of operation, etc.

A very substantial advantage of segregating payment transaction functionality is that it becomes independently testable against legislative requirements before uploading to the entertainment device 10 and, if desired, independent of the content executables 22. An exemplary test might include clearing of all banks, adding and removing credit of appropriate types, checking that exceptions are thrown when (for example) test code attempts to remove more cash than is available, or if it adds or removes credit of an unsupported type.

Preferably, the transaction module 106 implements a two-phase commit protocol. In an entertainment device, it is possible to crash or fail to execute a game play for a number of reasons including and not limited to loss of power or network. In such circumstances, the ideal behaviour of a system is that, on restarting the system, the credit bank will have reverted to the values it held before the credit was removed. The functionality is also of value when printing tickets and making other forms of payout: if the payout fails for any reason, the transaction can be cleanly reversed.

The credit handler 26 preferably returns a unique token when a generic ‘remove credit’ instruction is called on the credit handler 26. The credit removed is immediately debited in volatile memory representation of the banks 110-112, but the changes are not committed to persistent storage (e.g. local disk or other media) until the transaction has completed. It is possible to explicitly reverse changes made by effecting a rollback.

Numerous transaction types can be supported by the transaction module 106 and translation module 107, based on generic ‘addcredit’ and ‘removecredit’ payment instructions. These include: for ‘addcredit’—coins in, notes in, ticket in, promotion, winnings, card inserted; and for ‘remove credit’—payout, pay to play, card removed, etc.

Various banks may be maintained by the transaction module 106. Banks may be used to distinguish between monies that can be used to pay for playing content and to pay out to ensure that (for example) winnings are not used to play content or that promotion monies are not used for paying out, in accordance with the requirements of the domain of operation. The credit handler may enable transfer of credit between banks at the customer's request, to meet certain legislative requirements.

In some domains, two banks may be used: one for promotions and the other for cash. Credit in of type PROMOTION will go into the promotion bank, all other types will go into the cash bank. For credit out of the type PAYOUT, money may only be taken from the cash bank. Credit out of the type PAY_TO_PLAY will first be taken from the promotion bank, and then from the cash bank if there are insufficient funds in the promotion bank.

In another domain e.g. under UK rules, cash won from a betting game may not be used to stake on the game without an explicit transfer of funds between the winnings bank and the credit bank. Thus, two banks are used: one for credit, and one for winnings. Credit in of type WINNINGS goes into winnings bank. Credit in of the type PROMOTIONS will cause an exception as promotions are not supported. All other types will go into the credit bank. On credit out, if it is of type PAYOUT, money will be taken from the winnings bank first, then the credit bank. If it is PAY_TO_PLAY, cash may only be taken from the credit bank.

In another domain, it may be a requirement that if the cash in the bank exceeds a predetermined level, then the credit handler automatically initiates a payout sequence to reduce it to a legal level. Also, if a note is added, then only a small sum is added to the immediately playable cash bank: the rest is added to a notes bank. In order to play money in the notes bank, the customer must explicitly request a transfer of winnings.

The credit handler may determine the mode of use of the payment mechanism. For example, where the payment mechanism is a smart card reader, the value of cash held is written to the actual card which is inserted into a special peripheral. All credit in and credit out instructions result in writes to the card data directly. The card can be removed at any time and taken to another device to add more credit, or to redeem winnings.

Other embodiments are intentionally within the scope of the accompanying claims.

1. An entertainment device comprising:
a processor module;
one or more peripheral payment mechanisms;
an entertainment content handler and content interface executing on the processor module for executing entertainment content;
a credit handler module adapted for interfacing between the one or more peripheral payment mechanisms and the content handler to implement payment in and payment out functionality, the credit handler module comprising
(i) a first interface for communicating generic payment instruction messages to and from the content handler, said generic payment instruction messages being non-specific to plural types of payment mechanisms,
(ii) translation module for translating said generic payment instruction messages to and from specific payment functionality messages, said specific payment functionality messages being specific to each of said one or more peripheral payment mechanisms, and
(iii) a second interface for communicating said specific payment functionality messages to and from said one or more peripheral payment mechanisms.

2. The entertainment device of claim 1 in which the translation module is adapted to effect the translation between payment instruction messages and payment functionality messages as a function of domain of operation information retrieved from a location-specific configuration file in the entertainment device.

3. The entertainment device of claim 1 in which the credit handler module further includes a transaction processor for implementing transaction processing rules according to a domain of operation of the entertainment device.

4. The entertainment device of claim 3 in which the transaction processor is adapted to maintain one or more credit balances in respective one or more credit banks as a function of transactions initiated by said instruction and functionality messages.

5. The entertainment device of claim 4 in which the transaction module is adapted to implement transaction processing rules as a function of domain of operation information retrieved from a location-specific configuration file in the entertainment device.

6. The entertainment device of claim 5 in which the domain of operation information determines the transactions that may be applied to said one or more credit banks.

7. The entertainment device of claim 1 in which the generic payment instruction messages include payment in and payment out instructions.

8. The entertainment device of claim 1 in which the specific payment functionality messages comprise one or more of: coins received, bank notes received, ticket in, card inserted, card removed, payout.

9. The entertainment device of claim 1 in which the credit handler module is adapted to return an error message to said entertainment content handler if the credit handler module is unable to process or complete a transaction prescribed by a generic payment instruction message received from the content handler module.

10. The entertainment device of claim 3 in which the credit handler module and payment mechanism are adapted to implement a two-phase commit protocol in the event that a transaction with the payment mechanism is interrupted or cannot be completed.

11. A method of operating an entertainment device having an entertainment content handler executing entertainment content and one or more peripheral payment mechanisms, the method comprising:
generating generic payment instruction messages in the content handler, said generic payment instruction messages being non-specific to said one or more payment mechanisms;
translating said generic payment instruction messages to specific payment functionality messages in a credit handler module, said specific payment functionality messages being specific to each of said one or more peripheral payment mechanisms;
communicating said specific payment functionality messages to said one or more peripheral payment mechanisms to implement payment in and payment out functionality;
generating specific payment functionality messages in the one or more peripheral payment mechanisms;
translating said specific payment functionality messages to generic payment instruction messages in the credit handler module; and
communicating said generic payment instruction messages to said content handler.
